(19) United States
(12) Patent Application Publication
(10) Pub. No.: US 2007/0166431 A1
(43) Pub. Date: Jul. 19, 2007

(54) Producing and dispensing of liquor

(76) Inventor: Peter Camitz, Lidingo (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/547,343

(22) PCT Filed: Mar. 3, 2004
(86) PCT No.: PCT/SE04/00294

§ 371 Date: Jun. 20, 2006

Related U.S. Application Data
(60) Provisional application No. 60/319,989, filed on Mar. 3, 2003.

(30) Foreign Application Priority Data
Oct. 8, 2003 (SE) 0302677-0

(51) Int. Cl. C12C 11/00

(52) U.S. Cl. 426/11

(57) ABSTRACT

The invention relates to liquor, where liquor is an alcoholic beverage made by distillation, comprising ethanol and water wherein the liquor comprises CO2 being introduced and dissolved in the water. The invention also relates to a method and a device for producing liquor, use of a device for distributing beer, use of a device for producing lemonade, a method and a device for producing and dispensing liquor, a device for containing liquor, and use of a device for containing liquor.

### TECHNICAL FIELD

The present invention relates to liquor according to the preamble of claim 1. The present invention further relates to a method for producing liquor according to the preamble of claim 4, and a device for producing liquor according to the preamble of claim 10. The present invention still further relates to use of a beer distribution device according to the preamble of claim 12. In addition the present invention relates to a method for dispensing liquor according to the preamble of claim 14. The present invention further relates to a device for dispensing liquor according to the preamble of claim 29. The present invention still further relates to a method for producing liquor according to the preamble of claim 48. The present invention still further relates to a device for producing liquor according to the preamble of claim 53. The present invention also relates to use of a lemonade producing device according to the preamble of claim 58. The present invention also relates to a closure device according to the preamble of claim 59. The present invention further relates to use of a closure device according to the preamble of claim 62.

### BACKGROUND

Liquor, i.e. an alcoholic beverage made by distillation rather than by fermentation, has been consumed practically all over the world for a very long time. Liquor comprises ethanol and water. The concept of liquor comprises distillate of agricultural products, primarily potato and seed, but also berries and fruits can be used. Wine and malt beverages do not count as liquor. It is a desire to make the liquor taste good. This can be done by storing the distilled liquor, normally in a wooden cask, where scent and flavour is developed through the substances in the pores of the wood. It can also be done by flavouring neutral liquor, either by maceration, distillation (for a second time) or adding essences. Still there is a wish for achieving better scent and taste in liquor, particularly non-coloured and non-flavoured liquor, such as vodka, that is consumed straight, i.e. without mixing the liquor with other substances, such as soda, lemonade etc.

A normal way of serving liquor in bars is pouring it straight from the liquor bottles. In order to control the amount of liquor served, so that the customer gets the correct amount, measuring glasses are normally used. Another way of achieving the correct amount is to attach to the opening of the bottle devices with which a predetermined volume of liquor can be poured into the glass.

A problem with distributing draught beer is that the carbonic acid content in the beer decreases, i.e. the beer tends to become flat. This is solved by connecting a CO₂ cylinder with a pressure regulator to the beer keg, which facilitates regulation of the carbonic acid and thus the beer is kept fresh. Moreover the carbonic acid tends to evaporate if the beer is kept too warm. Therefore the beer is cooled with a cooler before it is transported to the tap. Such beer distribution systems comprising a CO₂ cylinder, a keg connected to the CO₂ cylinder, a cooler connected to the keg and a tap connected to the keg and the cooler, for distributing beer have been part of the prior art for many years. Apart from beer also other beverages, which are normally carbonated, such as cider, are used in beer distribution devices or the like.

A beverage product that has become popular lately is alcoholic carbonated lemonade, so called RTD (Ready To Drink), which is produced by mixing carbonated lemonade and liquor.

A problem with producing and distributing liquor according to the present invention is that it is difficult to receive the correct amount of liquor when serving smaller volumes, e.g. 10-100 ml, and also handle this in a quick and smooth way.

### SUMMARY OF THE TNVENTION

These and other problems, apparent from the following description, are solved by achieving the objects stated below, which are of the type stated by way of introduction and which in addition exhibits the features recited in the characterising clause of the appended claims 1, 4, 10, 12, 14, 29, 48, 53, 58, 59 and 62. Preferred embodiments of the inventive method and device are defined in appended sub claims 2-3, 5-9, 11, 13, 15-28, 30-47, 49-52, 54-57 and 60-61.

An object of the present invention is to provide a new kind of liquor, which in a better way releases the flavourings. This is achieved according to the characterising part of claim 1, i.e. by introducing CO₂ in the water of the liquor. An advantage is that the liquor tastes more fresh and, thus, better.

Another object of the present invention is to provide a method for producing a new kind of liquor, which in a better way releases the flavourings. This is achieved according to the characterising part of claim 4, i. e. by adding CO₂ to the liquor under pressure, cooling the carbonated liquor, and transferring the carbonated liquor to dispensing means. Advantages comprise the fact that existing beer distributing systems come close to the requirements that has to be offered for carrying out such a method. This is alternatively achieved according to the characterising part of claim 48. Advantages comprise the fact that existing carburettor devices provides an easy way of producing the liquor according to the present invention.

Preferably the method further comprises the feature of claim 5, i.e. the liquor is kept in a pressure vessel.

Preferably the method further comprises the features of claim 6, i.e. the step of transferring the liquor from the pressure vessel to a cooling device and further to said dispensing means by means of gas under pressure, said gas being introduced into the vessel.

Preferably the method further comprises the feature of claim 7, i.e. the liquor kept in the pressure vessel is pre-carbonated. An advantage with using pre-carbonated liquor is that this speeds up the distribution process, as the liquor does not have to be carbonated in the pressure vessel before it is transferred through the cooling device to the dispensing means.

Preferably the method further comprises the feature of claim 8, i.e. the gas is CO₂. This enables adding of CO₂ to the pre-carbonated liquor if needed.

Preferably the method further comprises the feature of claim 9, i.e. the CO₂ content is controlled by a pressure regulator. An advantage is that this control practically prevents the liquor from becoming flat.

A further object of the present invention is to provide a device for producing a new kind of liquor, which in a better way releases the flavourings. This is achieved by the characterising part of claim 10, i.e. the device comprises a pressure vessel for containing the liquor, a gas container for adding CO₂ to the liquor, connectable to said vessel, a cooling device for cooling the carbonated liquor, connectable to said vessel, and a channel for transferring the carbonated liquor to dispensing means. Advantages comprise the fact that existing beer distributing systems come close to the requirements that has to be offered for providing such a device. This is alternatively achieved according to the characterising part of claim 53. Advantages comprise the fact that existing carburettor devices provides an easy way of producing the liquor according to the present invention.

Preferably the device further comprises the feature of claim 11, i.e. the CO₂ content is controlled by means of a pressure regulator. An advantage is that this control prevents the liquor from becoming flat.

A further object of the present invention is to use an existing device for producing and distributing a new kind of liquor, which in a better way releases the flavourings. This is achieved by the characterising part of claim 12, i.e. use of beer distribution equipment comprising a gas container, a pressure vessel connectable to said gas container, a cooling device connectable to the pressure vessel and a tap for tapping liquid connectable to the pressure vessel and cooling device, for producing and distributing carbonated liquor. By using an existing device, i.e. beer distributing equipment, for producing and distributing carbonated liquor there is practically no extra cost for installing a new device, and thus there are huge practical advantages, as only the liquid has to be exchanged. Alternatively a new tap can be attached to the existing ones, which is a well-known procedure. An additional advantage is that safety components such as the pressure vessel and the pressure regulator are already approved by the authorities concerned. Also safety issues regarding handling of provisions are approved by the authorities concerned.

Preferably the use further comprises the feature of claim 13, i.e. the gas is CO₂ whereby CO₂ is added to the liquor when distributed. An advantage with using CO₂ as the gas introduced in the pressure vessel is that the carbonation of the liquor can be obtained there. When using pre-carbonated liquor this enables adding of CO₂ to the pre-carbonated liquor if needed.

A still further object of the present invention is to use an existing carbonated lemonade producing equipment, for example a carburettor, for producing a new kind of liquor, which in a better way releases the flavourings. This is achieved by the characterising part of claim 58. Advantages comprise the fact that existing carburettor devices provides an easy way of producing the liquor according to the present invention.

Yet another object of the present invention is to provide a new method for dispensing carbonated liquor according to the present invention, which in a better way gives the predetermined volume. This is achieved according to the characterising part of claim 14, i.e. by transferring the liquor under pressure to a dispensing device, and utilising said pressure for providing a dispensing stroke for a predetermined volume of the liquor. This solves the problem of receiving the correct amount of liquor when serving smaller volumes, e.g. 10-100 ml. It is convenient to use the pressure from the carbonated liquor as no extra force is then needed to provide the dispensing stroke.

Preferably the method further comprises the feature of claim 15, i.e. the step of bringing the pressure to act against a spring element. An advantage is that the spring element returns the stroke.

Preferably the method further comprises the feature of claim 16, i.e. a piston makes the dispensing stroke against a spring force. By using a known component such as a piston simplifies construction and reduces construction costs.

Preferably the method further comprises the feature of claim 17, i.e. the spring force is provided by a gas spring. As the gas spring is a closed component it can easily withstand liquid contact. A further advantage is that the gas spring can be constructed with a damper.

Preferably the method further comprises the feature of claim 18. Damping the gas spring mitigates foaming of the liquor during the dispensing stroke.

Preferably the method further comprises the feature of claim 19. Keeping the liquor cool further mitigates foaming of the liquor during the dispensing stroke.

Preferably the method further comprises the feature of claim 20, i.e. that a tray element is provided with at least one recess for placing the receiving elements, said receiving elements being for example glasses, cups or the like. The recesses prevent the glasses or the like from tilting and keep the glasses in the right position.

Preferably the method further comprises the feature of claim 22, i.e. for each step liquor of a predetermined volume is discharged into the corresponding receiving element. This gives the possibility of in a quick way pouring the liquor in glasses on a tray ready to serve.

Preferably the method further comprises the feature of claim 23. By using the pressure from the carbonated liquor for feeding the tray element for the receiving elements no extra force is needed.

Preferably the method further comprises the feature of claim 24. By using the pressure from the carbonated liquor for rotating the tray element no extra force is needed.

Preferably the method further comprises the feature of claim 27. An advantage by sending a signal back to the light source is that the valves only open, and consequently the dispensing stroke only occurs, if the light beam originates from the, to the respective sensor, corresponding light sources. As the frequencies of the light sources are in the different light sources there is practically no risk of detecting the wrong light beam.

A further object of the present invention is to provide a device for dispensing liquor. This is achieved by the characterising part of claim 29, i.e. arranging the device to receive the liquor which is transferred under pressure, and utilising said pressure for providing a dispensing stroke for a predetermined volume. An advantage is that this simplifies receiving the correct amount of liquor when serving smaller volumes, e.g. 10-100 ml. It is convenient to use the pressure from the carbonated liquor as no extra force is then needed to provide the dispensing stroke.

Preferably the device further comprises the feature of claim 31. As the gas spring is a closed component it can easily withstand liquid contact. A further advantage is that the gas spring can be constructed with a damper.

Preferably the device further comprises the feature of claim 32. A damper in the gas spring mitigates foaming of the liquor during the dispensing stroke, as the liquor will be more carefully poured.

Preferably the device further comprises the feature of claim 33. Keeping the liquor cool further mitigates foaming of the liquor during the dispensing stroke.

Preferably the device further comprises the feature of claim 36. The recesses prevent the glasses or the like from tilting and keep the glasses in the right position.

Preferably the device further comprises the feature of claim 37. This stepwise function gives the possibility of in a quick way pouring the liquor in glasses on a tray ready to serve.

Preferably the device further comprises the feature of claim 38. By using the pressure from the carbonated liquor for feeding the tray element for the receiving elements no extra force is needed.

Preferably the device further comprises the feature of claim 39. By using the pressure from the carbonated liquor for rotating the tray element no extra force is needed.

Preferably the device further comprises the feature of claim 45. An advantage is that the valves only open, and consequently the dispensing stroke only occurs, if the light beam originates from the, to the respective sensor, corresponding light sources.

Preferably the device further comprises the feature of claim 46. By having a substantially transparent container the carbonated liquor can during the dispensing stroke be seen by the consumers.

Preferably the device further comprises the features of claim 47. Advantages comprise the fact that existing beer distributing systems come close to the requirements that has to be offered for providing such a device and by replacing a beer tap with the dispenser the device further comprises the advantages according to anyone of claims 29-46.

Another object of the present invention is to provide a closure device for containing a carbonated liquid under pressure in a container, for example a bottle, such that the pressure remains in the container, according to the characterising part of claim 59, i.e. that the cork at least on the surface is of a material which is inert relative to the liquor so that neither taste nor colour is transferred from said material to the liquor. An advantage is that the carbonated liquor is not coloured and does not taste bad.

Preferably the closure element further comprises the feature of claim 60, i.e. that the cork is expandable. This gives a very good closure of the carbonated liquor and the cork, when pulled off, is not re-attachable, which gives the message that the carbonated liquor is supposed to be consumed directly i.e. before becoming flat.

Preferably the closure element further comprises the feature of claim 61, i.e. the cork is coated with said inert material. An advantage is that a normal champagne cork can be used.

A further object of the present invention is to use a closure element for containing a carbonated liquid in a container under pressure such that the pressure remains in the container, according to the characterising part of claim 62, i.e. that the liquid is carbonated liquor. By containing the carbonated liquor in a container under pressure the liquor can be stored without becoming flat, and then be consumed at a later stage.

### DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1a shows schematically a device for producing and distributing liquor according to a first embodiment the present invention;

FIG. 1b shows schematically an alternative device for producing liquor according to a second embodiment of the present invention;

FIG. 2 shows a side view of a device for dispensing liquor according to one aspect of the present invention;

FIG. 3 shows a plan view of the device in FIG. 2;

FIG. 4 shows a cross-section of the device in FIG. 2 along the line I-I in FIG. 3

FIG. 5 shows schematically a preferred embodiment of a device for producing and dispensing liquor according to one aspect of the first embodiment of the present invention;

FIGS. 6a and 6b show schematically a detecting arrangement according to one aspect of the present invention; and

FIG. 7 shows schematically a closure device for containing the liquor according to one aspect of the present invention.

### DETAILED DESCRIPTION OF THE INVENTION

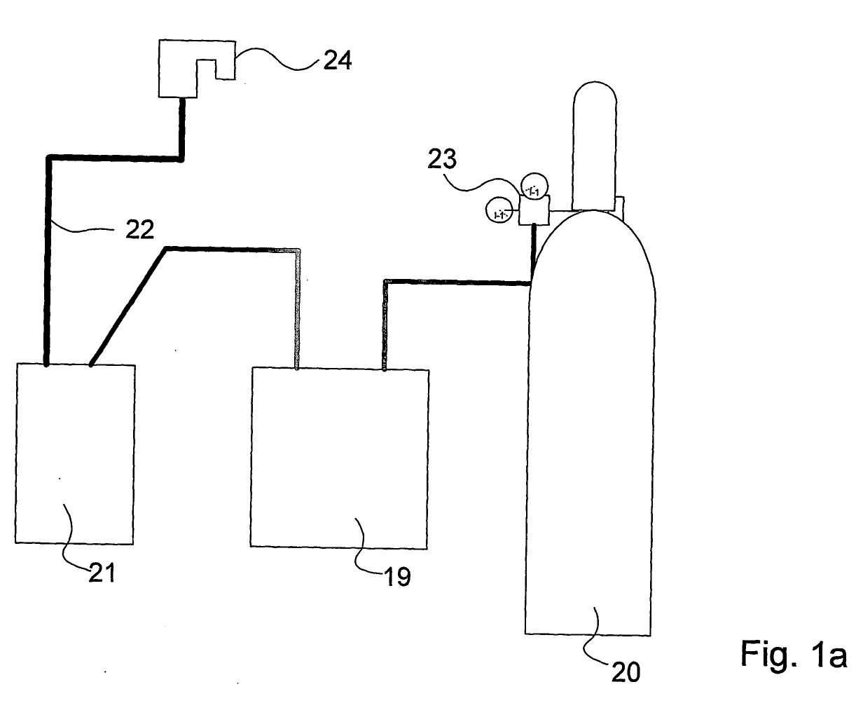

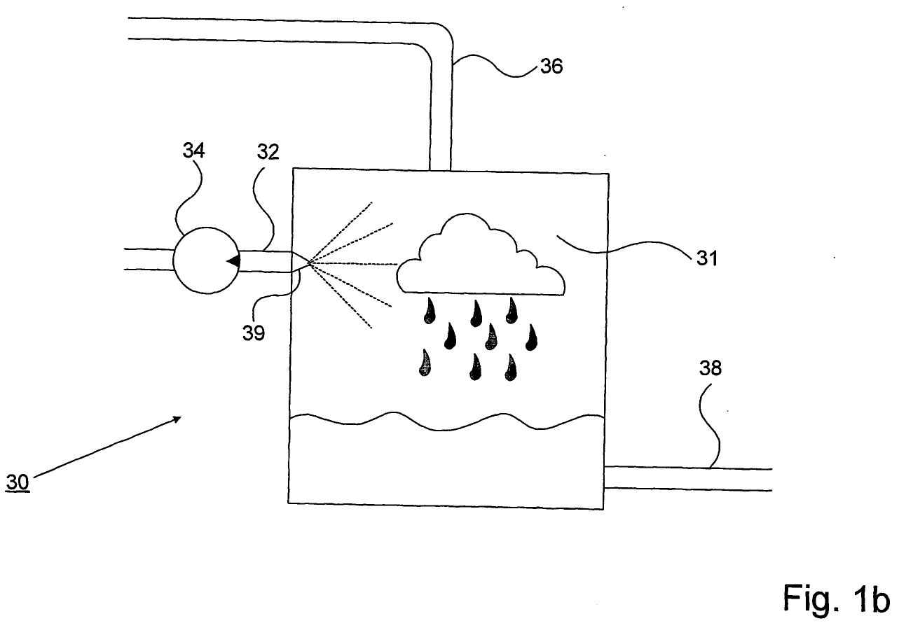

FIG. 1a shows a device for producing and distributing liquor according to a preferred embodiment of the present invention, comprising a pressure vessel 19, a gas container 20, a cooling device 21 arrangement, a channel 22, and a tap 24. The gas container 20 is connected to the pressure vessel 19, the pressure vessel 19 is connected to the cooling device 21 in such a way that liquid from the pressure vessel 19 is cooled on its way to the tap, and the cooling device 21 is connected to the tap 24 via a channel 22.

The liquor, which is an alcoholic beverage made by distillation rather than by fermentation, can be any kind of liquor such as non-flavoured liquor, flavoured non-coloured liquor, coloured liquor etc. with any kind of ethanol content. Preferably though the liquor is vodka. The liquor is kept in the pressure vessel 19 and is transferred through the cooling device 21 to the tap 24 by means of pressure generated by gas from the gas container 20. The cooling device 21 cools the carbonated liquor to prevent evaporation of the carbonic acid and thus the liquor tapped from the tap 24 is cool and fresh. In a preferred embodiment the gas is CO₂ and the liquor in the pressure vessel 19 is pre-carbonated. Alternatively the carbonation of the liquor can be obtained in the pressure vessel 19 by introducing sufficient CO₂ from the gas container 20 into the pressure vessel 19. To avoid that the carbonated liquor becomes flat a pressure regulator 23 is attached to the gas container 20, so that the CO₂ content introduced in the pressure vessel can be controlled.

The device used for producing and distributing carbonated liquor is preferably approximately identical to an existing beer distributing equipment. This is very advantageous as the equipment already exists in practically every bar, which means practically no extra installations. By using an existing device the equipment only has to be cleaned, which is a well-known procedure, before introducing the liquor into the pressure vessel. It is also straight forward to introduce an additional tap 24, and if needed an additional channel 22 and cooler 21. This is quite commonly done by such beer distributing devices when the demand increases.

The carbonated liquor is produced by introducing and dissolving CO₂ in the water of the liquor. This differs from RTD (Ready To Drink), which is produced by mixing carbonated lemonade and liquor, where the water of the liquor initially is not carbonated.

FIG. 1b shows a device for producing and distributing carbonated liquor according to an alternative embodiment of the present invention. The device comprises a container 31, a liquid inlet 32 for introducing liquid into the container, said liquid inlet 32 being located at the upper part of the container 31, a pump 34 for pumping the liquid, a gas inlet 36 for introducing gas, preferably CO2, into the container 31, said gas inlet 36 being located at the top of the container 31, and an outlet 38 for discharging the gas/liquid mixture located at the lower part of the container 31. The device is preferably a carburettor 30 used for producing carbonised liquid by introducing water into the liquid inlet 32. A nozzle 39 is arranged at the liquid inlet 32 such that the liquid is sprayed into the container and instantly mixed with the gas. The mixed liquid falls to the bottom of the container 31 as rain. The same amount introduced into the container 31 is at the same time discharged from the container 31. By introducing liquor, preferably vodka, into the container 31 and mixing it with the gas, i.e. CO2, carbonised liquor is received via the outlet 38. The liquor is preferably cooled before introduced into the container. By cooling the liquor before introducing it the solubility of the gas is controlled. For the same reason the container 31 is also kept at a desired temperature.

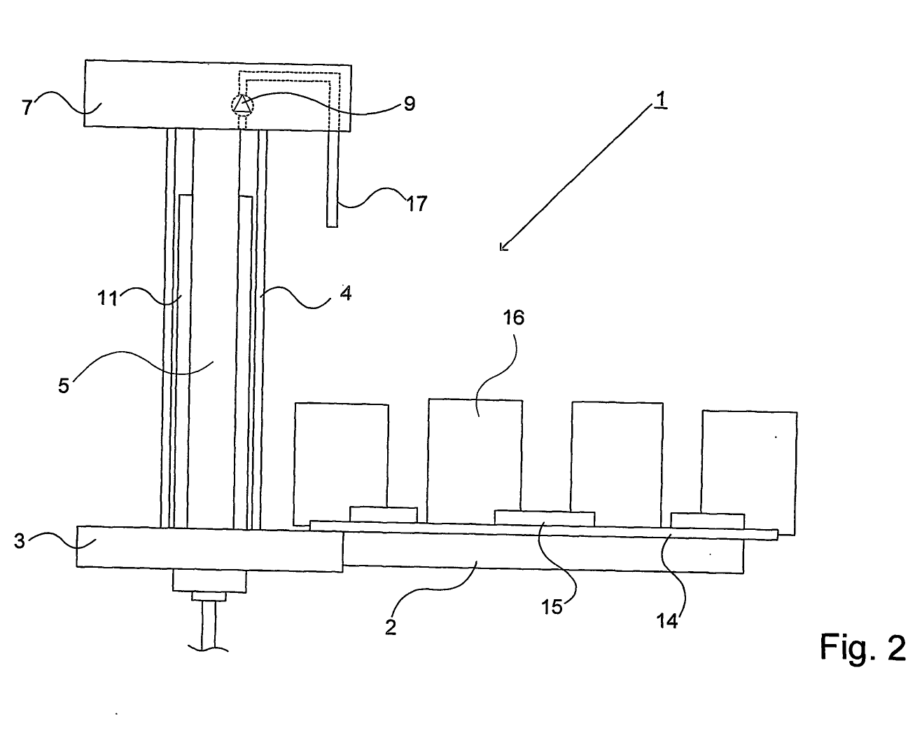

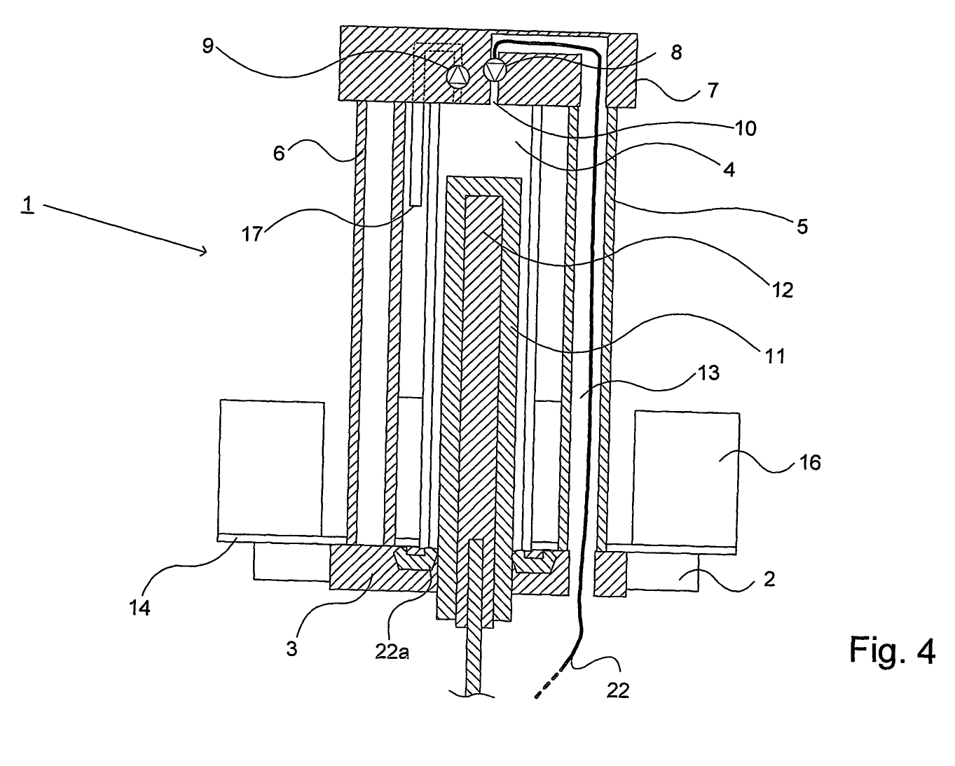

FIGS. 2, 3 and 4 show a device 1 for dispensing liquor according to a preferred embodiment of the present invention, comprising a substantially horizontal tray element, 2, a substantially horizontal bottom plate 3, where the side of the tray element 2 is rotatably arranged to the side of the bottom plate 3, which bottom plate upholds a substantially upright container 4, and two substantially upright supports 5, 6 leading up to a substantially horizontal top plate 7, which is placed on the supports 5, 6, wherein said top plate 7 comprises a first and a second valve 8, 9, and an inlet 10, connected to the first valve 8, leading to said container 4. The dispensing device 1 further comprises a piston 11 located in the container 4, and a spring element 12 upon which the piston 11 is arranged to act. The bottom plate 3 has an opening on the lower end which forms a channel 13 leading through the bottom plate 3, further through one of the supports 5 entering, through the support 5, the lower end of the top plate 7 and finally terminating at the inlet 10. Through the channel 13 a pipe 22 is lead, from the opening in the bottom plate 3, via the support 5 and the top plate 7, to the inlet 10. On the tray element 2 is a tray 14 removably attached, wherein the tray comprises recesses 15 on its peripheral surface, said recesses being formed such that drinking glasses 16 can be closely received therein. The dispensing device further comprises an outlet 17 connected to the second valve, and triggering means for triggering the valves. The container is preferably a glass cylinder, and is thus substantially transparent, and the spring element is preferably a gas spring.

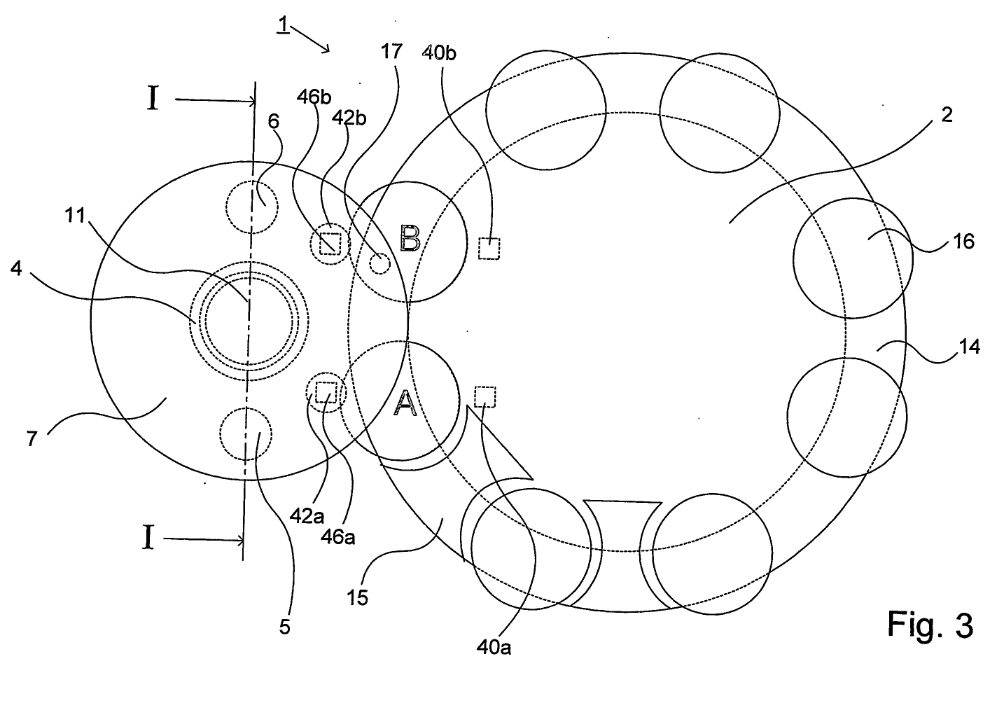

FIG. 3 is a plan view of the dispensing device of FIG. 2 showing that the glass cylinder 4 preferably is located on the centre of the bottom plate 3, and the piston 11 is placed at the centre of the lower end of the cylinder 4. The two supports 5, 6 are located on each side of the glass cylinder 4 on an imaginary diameter line drawn through the centre of the glass cylinder 4, and the tray element 2 is located so that an imaginary diameter line on the bottom plate 3, which line is perpendicular to the diameter line drawn through the supports 5, 6, along its extension provides an imaginary line on the tray element 2.

When operated cooled carbonated liquor is transferred under pressure in the pipe 22 through to the inlet 10, the first valve 8 being open so that the pressurised liquor enters the glass cylinder 4, wherein the pressure forces the piston 11, said piston 11 being at its starting position at the top of the cylinder 4, to act against the gas spring 12, i.e. forcing it downwardly, whereas the glass cylinder 4 is filled to a predetermined volume with the carbonated liquor. The tray element 2 is arranged to rotate one step so that the glass on the tray 14 is positioned directly below the outlet 17. When this dispensing stroke is performed, i.e. when the cylinder 4 is filled with a predetermined volume, e.g. 40 ml, the second valve 9 opens and the gas spring forces the piston 11 upwards and thus the liquor out of the outlet 17 and into the glass 16. When the piston 11 has reached its starting position the second valve 9 closes and the first valve 8 opens again and the procedure is repeated. Preferably the tray 14 element is arranged to rotate as the gas spring 12 is forced downwardly by the piston 11, i.e. by the pressure.

Measuring means are arranged such that the predetermined volume of the liquor is measured up under pressure. By measuring under pressure the result will become more accurate as the pressure prevents CO₂ to be dissolved out from the carbonic acid which would create a space in the measuring cavity and thus give a less precise result.

In order to have the glasses 16 positioned correctly, i.e. stops under the outlet 17 when the tray element 2 rotates step wise, and are ready to receive the liquor, and also to prevent the glasses 16 from tilting while rotating and while the tray is removed and carried by the waiter/waitress/customer, recesses 15 are formed on the peripheral surface of the tray 14 within which the lower part of the glasses 16 are closely received.

Detecting means are arranged such that if the glass 16 is empty the first valve 8 opens and liquor is discharged into the container 4 as the tray 14 rotates one step such that the glass 16 moves to the next position. When the empty glass is in that position, i.e. positioned under the outlet, a second valve 9 is arranged to open and liquor is discharged into the glass 16 ending one dispensing stroke. The procedure continues until all glasses 16 are filled. The tray 14 can then easily be removed and is ready to serve.

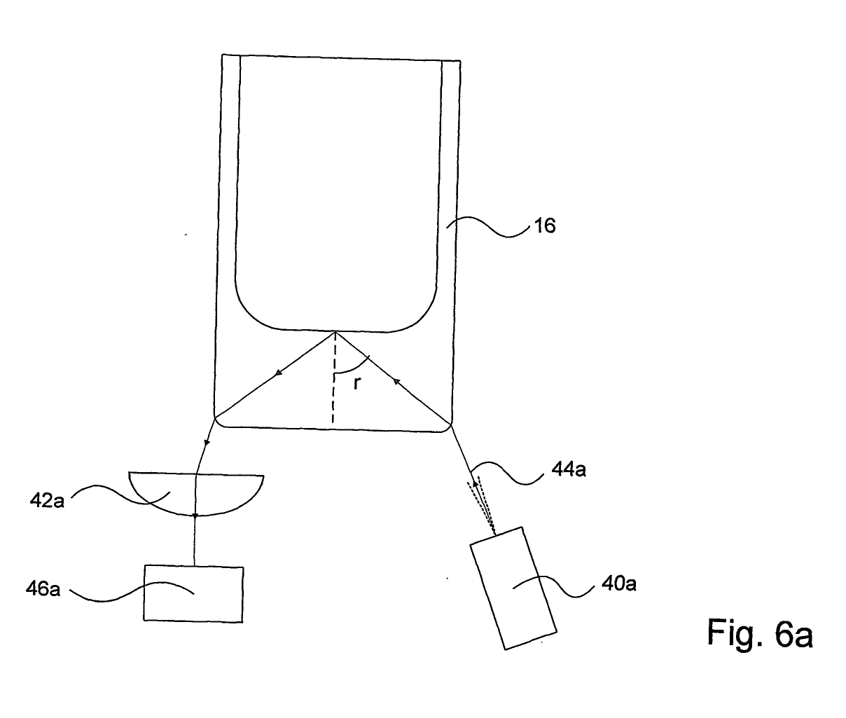

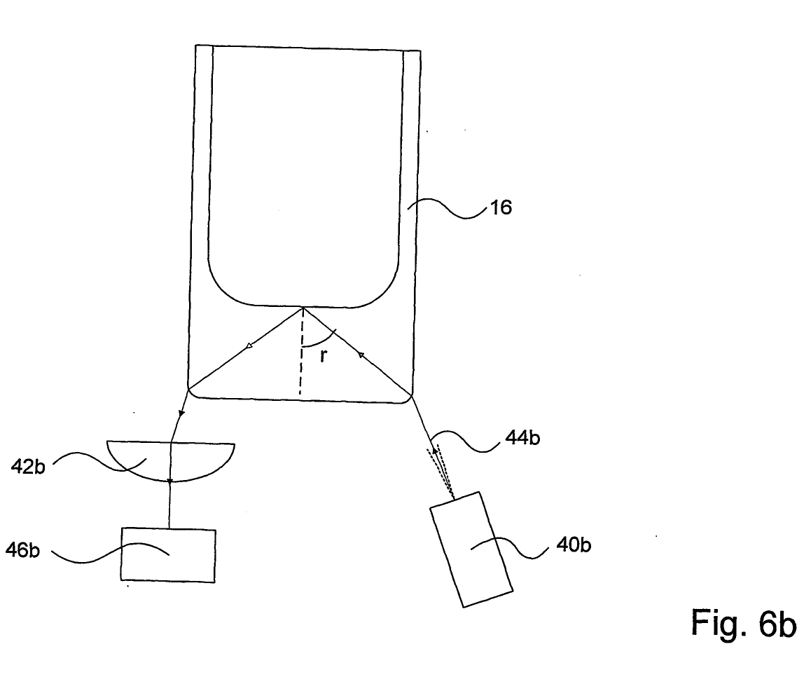

Preferably the detecting means is an optical detecting arrangement. FIGS. 6a and 6b show a detecting arrangement according to a preferred embodiment of the present invention comprising a light source 40a, 40b, preferably a light emitting diode, arranged below the glass 16 to be detected, a lens 42a, 42b arranged below the glass 16 opposite to the light source 40a, 40b in such a way that a light beam 44a, 44b from the light source is refracted and reflected such that it is captured by the lens 42a, 42b, and a sensor 46a, 46b arranged below the lens 42a, 42b such that the light beams 44a, 44b collected by the lens 42a, 42b are focused against the sensor 46a, 46b, which detects the light beam 44a, 44b. As the glass 16 has a refraction index of approximately 1.5, the liquid a refraction index of approximately 1.3, and air a refraction index of approximately 1, and consequently the fact that there is a big difference between the refraction index of air and glass as is the case when the glass is empty, the light beam is reflected when the glass 16 is empty. If the angle r is greater than approximately 42°, which is the critical angle of total reflection, total reflection occurs (according to sin r=n₂/n₁ where n₁ is the refraction index of glass and n₂ is the refraction index of air). When the glass is filled with the carbonated liquor, practically no reflection occurs. The glass 16 is designed in such a way, i.e. having a bottom with a certain thickness, that the effect of the light beam 44a, 44b being reflected when the glass 16 is empty and basically no reflection occurs when the glass 16 is filled with the carbonated liquor is optimised. Preferably a light source, for example a light emitting diode, suitable for visible light having a radial angle of approximately 5° is used.

The light beam 44a, 44b, thus, is refracted as it enters the glass 16 and then, if the glass 16 is empty, reflected when reaching the bottom of the glass 16, and further refracted when leaving the glass 16 on the opposite side, reaching the lens 42a, 42b, which collects the beams 44a, 44b such that they are focused to one beam which then reaches the sensor 46a, 46b. There is a light emitting diode arranged under each glass 16 and the two diodes 40a, 40b arranged under the two forward most glasses 16 respectively, i.e. the glasses 16 located in position A and B, i.e. closest to the supports 5, 6 (see e.g. FIG. 3) have a triggering function in connection with the lens 42a, 42b. In position A there is alight emitting diode 40a, a lens 42a and a sensor 46a and correspondingly in position b, a light emitting diode 40b, a lens 42b and a sensor 46b arranged a s described above.

When operated an empty glass 16 on the tray is moved to position A, which is the “standby position”. The light emitting diode 40a transmits a light beam 44a which is reflected at the bottom of the glass 16 and then having left the glass captured by the lens 42a and detected by the sensor 46a. The sensor 46a then sends a signal to valve triggering means, which is arranged such that the valve 8 opens. The pressurised liquor then enters the glass cylinder 4 wherein the piston 11 is forced down and the glass cylinder is filled to a predetermined volume as described above. As the piston moves, the tray element 2 is moved one step such that the glass stops at position b, i.e. below the outlet 17. Now correspondingly as in position A the light emitting diode 40b transmits a light beam which is reflected at the bottom of the glass 16 and then having left the glass captured by the lens 42b and detected by the sensor 46b. The sensor 46b then sends a signal to valve triggering means, which is arranged such that the valve 9 opens. The gas spring then forces the piston upwards and the liquor out of the outlet 17 and into the glass 16. If a glass 16 located in a detection position is removed the outlet valve does not open. The valves 8, 9 are further arranged such that both can not be open at the same time. There is thus substantially no risk of spilling liquor during the process. There are a certain number of equal diodes, i.e. one for each glass respectively, preferably 10, of which two are controlled by a respective sensor 46a, 46b.

In order to prevent the sensors 46a, 46b from being disturbed by other signals they are arranged such that they only recognise signals, from their respective light emitting diode. This is done in such a way that when for example the sensor 46a detects the signal originating from the light emitting diode 40a, the sensor sends a signal back to the light emitting diode 40a which is controlled such that as long as it receives this signal it continues to emit light. The sensor only detects light having a certain frequency, i.e. the frequency of the light emitted from the diode 40a. If light from a different light source, i.e. a different frequency, reaches the sensor 46a, no signal is sent back to the diode 40a. Correspondingly the diode 40b is controlled by the sensor 46b, which only detects light coming from the diode 40b, and sends it back to the diode 40b. In order to prevent light originating from one diode, e.g. 40a being detected by the other sensor 46b the diodes 40a and 40b have different frequencies. There is further a delay of for example approximately 0.5 seconds of the signal emitted from the diodes 40a, 40b.

There is further arranged a radio transmitter in the dispenser 1, which radio transmitter may be controlled by a laptop or the like. The radio transmitter is arranged such that for example the amount of liquor, the number of shots (glasses of liquor), the date and time when the liquor was poured are detected and registered.

To avoid that the cooled liquid becomes to warm when introduced in the dispensing device 1 coolant is introduced to keep it at a certain temperature. The glass cylinder 4 is preferably provided with double glasses such that a first upright glass of the cylinder 4 is surrounded by a second glass so that there is a cavity between the glasses of the cylinder 4, where the coolant can be introduced. Further the glass cylinder 4 is sealed with sealing means 22a at the bottom such that it is liquid tight. This can preferably be done with some kind of sealing or the like.

There are of course different solutions for providing the dispensing stroke. For example instead of using a spring element 12 for forcing the piston 11 back to its starting position the pressure used to force the piston 11 downwardly, i.e. using a double-acting cylinder, can also be used to push it back to the starting position.

There are also different methods for operating the tray element 2. For example a step motor triggered e.g. by the piston 11 can be used.

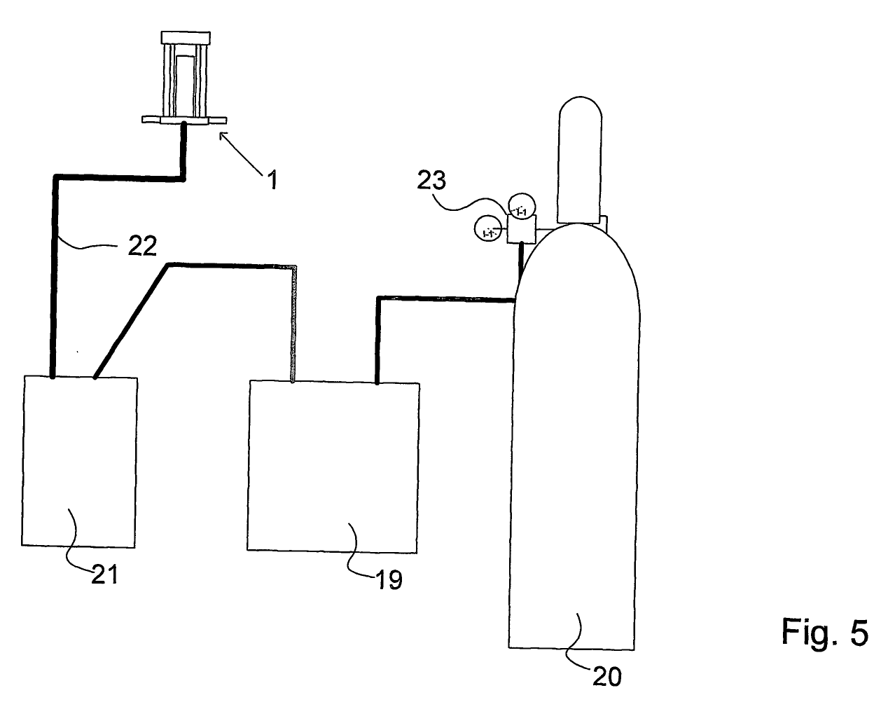

FIG. 5 shows a preferred embodiment of a device for producing and dispensing carbonated liquor according to a preferred embodiment of the present invention, comprising a pressure vessel 19, a gas container 20, a cooling device 21 arrangement, a pipe 22, and the dispensing device 1. The gas container 20 is connected to the pressure vessel 19, the pressure vessel 19 is connected to the cooling device 21 in such a way that liquid from the pressure vessel 19 is cooled on its way to the dispensing device 1, and the cooling device 21 is connected to the dispensing device 1 via a pipe 22.

The liquor is kept in the pressure vessel 19 and is transferred through the cooling device 21 to the dispensing device 1 by means of pressure generated by gas from the gas container 20. The cooling device 21 cools the carbonated liquor to prevent evaporation of the carbonic acid and thus the liquor introduced in the dispensing device 1 is cool and fresh. In a preferred embodiment the gas is CO₂ and the liquor in the pressure vessel 19 is pre-carbonated. Alternatively the carbonation of the liquor can be obtained in the pressure vessel 19 by introducing sufficient CO₂ from the gas container 20 into the pressure vessel 19. To avoid that the carbonated liquor becomes flat a pressure regulator 23 is attached to the gas container 20, so that the CO₂ content introduced in the pressure vessel 19 can be controlled.

The device used for producing and distributing liquor is preferably approximately identical to an existing beer distributing equipment. This is very advantageous as the equipment already exists in practically every bar, which means practically no extra installations. By using an existing device the equipment only has to be cleaned, which is a well-known procedure, before introducing the liquor into the pressure vessel 19. It is also straight forward to introduce an additional dispensing device, and if needed an additional pipe and cooler.

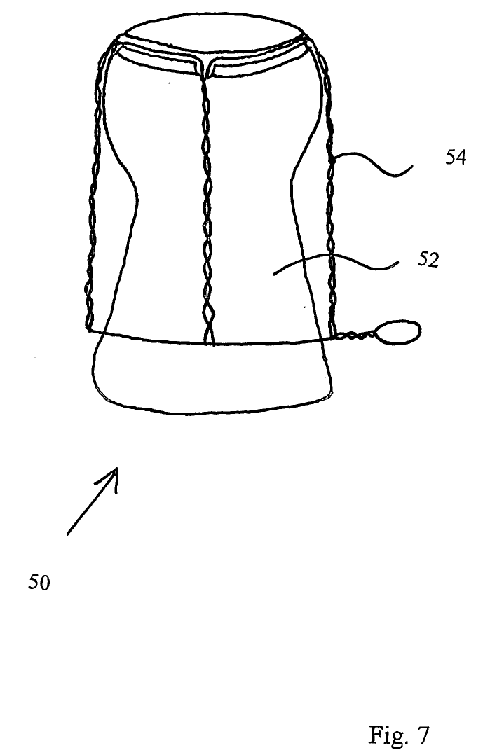

FIG. 7 shows a closure device for containing the liquor according to an embodiment of the present invention. The closure device is preferably a cork similar to those used to close champagne bottles. The cork is preferably of a material which is inert relative to the liquor so that neither taste nor colour is transferred from said material to the liquor, i.e. in order to prevent the liquor from being coloured and/or taste bad, which a normal cork may cause in contact with liquor. The cork is further constructed in such a way that when removed from the bottle it expands making it generally impossible to put back. Of course other materials having the above mentioned features may also be used. As in champagne bottles, a wire, i.e. a muselet, is arranged in a slit arrangement about the cork and is twined such that it forms a loop and a foil is preferably tightly arranged about the cork and the bottleneck. This is, apart from making the product look very exclusive as is the case of champagne, an efficient way of confining the carbonated liquor and at the same time avoiding that the carbonated liquor becomes coloured.

Alternatively the cork can be of a cork material having said inert material coated about the cork in such a way that it is expandable.

Part of the present invention is also use of existing devices for storing the carbonated liquid under pressure, such as champagne bottles, for storing the carbonated liquor. By containing the carbonated liquor in a container, such as a champagne bottle or the like, under pressure the liquor can be stored without becoming flat, and then be consumed at a later stage. By using a champagne bottle or the like, and particularly a cork like the ones used to contain fine champagne or the like in champagne bottles or the like, gives the product a luxurious and exclusive image.

Above the invention has been described in connection with preferred embodiments. Of course further embodiments as well as minor changes and additions may be imagined without deserting the basic inventive idea.

1. Liquor, where liquor is an alcoholic beverage made by distillation, comprising ethanol and water wherein the liquor comprises CO₂ being introduced and dissolved.

2. Liquor according to claim 1, wherein the ethanol content is more than 20% by volume.

3. Liquor according to claim 1, wherein the liquor is vodka.

4. Method for producing liquor, where liquor is an alcoholic beverage made by distillation, comprising ethanol and water, characterised by the steps of:
Obtaining carbonated liquor by adding CO₂ to the liquor under pressure;
cooling the carbonated liquor;
transferring the carbonated liquor to dispensing means (1, 24).

5. Method according to claim 4, characterised by the step of keeping the liquor in a pressure vessel (19).

6. Method according to claim 5, characterised by the step of transferring the liquor from the pressure vessel (19) to a cooling device (21) and further to said dispensing means (1, 24) by means of gas under pressure, said gas being introduced into the vessel (19).

7. Method according to claim 5, wherein the liquor kept in the pressure vessel (19) is pre-carbonated.

8. Method according to claim 5, wherein the gas is CO₂.

9. Method according to claim 4, wherein the CO₂ content is controlled by a pressure regulator (23).

10. Device for producing liquor, where liquor is an alcoholic beverage made by distillation, comprising ethanol and water, wherein the device comprises a pressure vessel (19) for containing the liquor, at least one gas container (20), for adding CO₂ to the liquor, connectable to said vessel (19), a cooling device (21), for cooling the carbonated liquor, connectable to said vessel (19), and a channel (22) for transferring the carbonated liquor to dispensing means (1, 24).

11. Device according to claim 10, wherein a pressure regulator (23) is attached to the gas container (20).

12. Use of beer distribution equipment comprising a gas container (20), a pressure vessel (19) connectable to said gas container (20), a cooling device (21) connectable to the pressure vessel (19) and a tap (24) for tapping liquid connectable to the pressure vessel (19) and the cooling device (21), for producing and distributing carbonated liquor, where liquor is an alcoholic beverage made by distillation.

13. Use of beer distribution equipment according to claim 11, wherein the gas is CO₂, whereby CO₂, or a mixture with CO₂, is added to the liquor when distributed.

14. Method for dispensing carbonated liquor, where liquor is an alcoholic beverage made by distillation, comprising ethanol and water, wherein CO₂ is added to the liquor under pressure and where the carbonated liquor is being cooled, characterised by the steps of
transferring the liquor under pressure to a dispensing device (1);
utilising said pressure for providing a dispensing stroke for a predetermined volume of the liquor.

15. Method according to claim 14, characterised by the step of bringing the pressure to act against a spring element (12).

16. Method according to claim 15, wherein a piston (11) makes the dispensing stroke against a spring force.

17. Method according to claim 16, wherein the spring force is provided by a gas spring (12).

18. Method according to claim 17, characterised by damping the gas spring during the dispensing stroke.

19. Method according to claim 14, characterised by keeping the liquor cooled when introduced in the dispensing device (1).

20. Method according to claim 14, characterised by providing a tray element comprising at least one recess for placing the receiving elements (16), said receiving elements (16) being for example glasses, cups or the like.

21. Method according to claim 20, characterised by rotating the tray element (2).

22. Method according to claim 20, characterised by rotating the tray element (2) one step for each dispensing stroke in such a way that for each step liquor of a predetermined volume is discharged into the corresponding receiving element (16).

23. Method according to claim 20, characterised by using the pressure for feeding the tray element (2).

24. Method according to claim 23, characterised by using the pressure via the motion of the piston (11) for rotating the tray element (2).

25. Method according to claim 14, characterised by using optical detection means, comprising at least one light source (40a, 40b), for example a light emitting diode, and at least one sensor (46a, 46b), for controlling the dispensing stroke.

26. Method according to claim 25, characterised by the steps of:
using said light source (40a) for emitting a light beam (44a) against the glass (16) being in a standby position (A);
using said sensor (46a) for detecting the, from an empty glass (16), reflected light beam;
sending a signal from the sensor (46a) for triggering the opening of a valve (8), said valve (8) releasing the pressurised liquor into the container (4) such that the piston (11) moves and the tray (14) rotates one step such that the glass (16) moves to a pouring position (B);
using said light source (40b) for emitting a light beam (44b) against the glass (16) being in the pouring position (B);
using said sensor (46b) for detecting the, from the empty glass (16), reflected light beam;
sending a signal from the sensor (46b) for triggering the opening of a valve (9), said valve (9) releasing the liquor through the outlet (17) into the glass (16).

27. Method according to claim 26, characterised by the steps of:
prior to triggering the opening of said valve (8) when having detected the light beam (44a), said light beam having a certain frequency originating from the light source (40a), sending another signal back to the same light source (40a) for reactivating the light source (40a);
prior to triggering the opening of said valve (9) when having detected the light beam (44b), said light beam (44b) having a certain frequency, said frequency differing from the frequency of the light beam (44a) emitted from the light source (40a), originating from the light source (40b), sending another signal back to the same light source (40b) for reactivating the light source (40b).

28. Method according to claim 14, characterised by the steps of:
keeping the liquor in a pressure vessel (19);
transferring the liquor from the pressure vessel (19) to a cooling device (21) and further to said dispensing device (1) by means of gas under pressure, said gas being introduced into the vessel (19).

29. Device for dispensing carbonated liquor, i.e. an alcoholic beverage made by distillation, comprising ethanol and water, comprising means for adding CO₂ to the liquor under pressure and for cooling the carbonated liquor, wherein the device is arranged to receive the liquor, which is transferred under pressure, and for utilising said pressure for providing a dispensing stroke for a predetermined volume.

30. Device according to claim 29, wherein the device (1) comprises at least one inlet (10) where the liquor is introduced, a container (4) provided below the inlet (10), a piston (11) arranged in the container (4), a spring element (12) against which the piston is arranged to make the dispensing stroke, and at least one outlet (17) for discharging the liquor to at least one receiving element (16), for example a glass (16).

31. Device according to claim 30, wherein the spring element (12) is a gas spring.

32. Device according to claim 31, wherein the gas spring (12) comprises damping means.

33. Device according to claim 29, wherein the device (1) is arranged to keeping the liquor cool.

34. Device according to claim 29, wherein the device (1) further comprises a tray element (2).

35. Device according to claim 34, wherein the tray element (2) is arranged to rotate.

36. Device according to claim 34 , wherein the tray element (2) comprises at least one recess (15) provided for placing the receiving elements (17), said receiving elements (16) being for example glasses, cups or the like.

37. Device according to claim 34, wherein the tray element (2) is arranged to rotate one step for each dispensing stroke in such a way that for each step liquor of a predetermined volume is discharged into the corresponding receiving element (16).

38. Device according to claim 34, wherein the pressure is arranged to feed the tray element (2).

39. Device according to claim 38, wherein the pressure via the motion of the piston (11) is arranged to rotate the tray element (2).

40. Device according to claim 30, wherein said device comprises a valve (8) arranged to open for introducing the pressurised liquor into the container (4) and a valve (9) arranged to open for discharging the liquor through the outlet (17).

41. Device according to claim 29, wherein optical detecting means are arranged to control the dispensing stroke.

42. Device according to claim 41, wherein said detecting means comprises at least one light source (40a, 40b), for example a light emitting diode, arranged below the glass (16) in a position close to the two glasses (16) being in their forward most position (A, B) relative to the bottom plate (3) such that an emitted light beam is reflected in the bottom of the glass if the glass is empty and refracted if the glass contains liquid, and at least one sensor (46a, 46b) arranged below the glass (16) opposite the light source (40a, 40b) in such a way that it detects the reflected light.

43. Device according to claim 42, wherein the sensor (46a) when having received a light beam (44a) is arranged to send a signal for triggering the valve (8) to open, and the sensor (46a) when having received a light beam (44b) is arranged to send a signal for triggering the valve (9) to open.

44. Device according to claim 42, wherein the sensor (46a, 46b) is arranged to only accept a light beam (44a, 44b) originating from the corresponding light source (40a, 40b).

45. Device according to claim 42, wherein the sensor (46a) when having received a light beam (44a) from the light source (40a) is arranged to send a signal for reactivating said light source (40a), and the sensor (46b) when having received a light beam (44b) from the light source (40b) is arranged to send a signal for reactivating said light source (40b).

46. Device according to claim 30, wherein the container (4) is substantially transparent.

47. Device according to claim 29, for producing carbonated liquor, wherein the device further comprises a pressure vessel (19) for containing the liquor, at least one gas container (20), for adding CO₂ to the liquor, connectable to said vessel (19), a cooling device (21), for cooling the carbonated liquor, connectable to said vessel (19), and a pipe for transferring the carbonated liquor to said dispensing device.

48. Method for producing liquor, where liquor is an alcoholic beverage made by distillation, comprising ethanol and water, characterised by the steps of:
introducing liquor into a container (31);
introducing gas, for example CO₂, into the container (31);
mixing the liquor with the gas; and
discharging the mixture.

49. Method according to claim 48, characterised by pre-cooling the liquor before introducing it into the container (31).

50. Method according to claim 48, characterised by spraying the liquor into the container (31).

51. Method according to claim 48, characterised by introducing the liquor and the gas, for example CO₂, preferably at the upper part of the container (31), at substantially the same time.

52. Method according to claim 48, characterised by pumping the liquor into the container (31).

53. Device for producing liquor, where liquor is an alcoholic beverage made by distillation, comprising ethanol and water, wherein the device comprises a container (31), a liquor inlet (32) for introducing liquor into the container (31), a gas inlet (36) for introducing gas, for example CO₂, into the container (31), said liquor inlet (32) and gas inlet (36) being arranged such that the liquor is mixed with the gas, and an outlet (38) for discharging the mixture.

54. Device according to claim 53, wherein a pump (34) for pumping the liquor through the liquor inlet (32) into the container (31).

55. Device according to claim 53, wherein a nozzle (39) for spraying the liquor into the container (31), arranged at the liquor inlet (32).

56. Device according to claim 53, wherein said liquor inlet (32) and said gas inlet (36) are arranged at the upper part of the container (31).

57. Device according to claim 53, wherein the device (30) is a carburettor (30).

58. Use of a carbonated lemonade producing equipment, for example a carburettor, comprising a container (31), an inlet (32) for introducing water into the container (31), a pump (34) for pumping water into the water inlet (32) connected to said inlet (32), a gas inlet (36) for introducing CO₂ into the container (31), said water inlet (32) and gas inlet (36) being arranged such that the water is mixed with the gas, and an outlet (38) for discharging the mixture, for producing carbonated liquor.

59. Closure device (50) for containing a carbonated liquid under pressure in a container, for example a bottle, such that the pressure remains in the container, comprising a closure element (52), an anchoring element (54), for example a wire (54), provided about the closure element and a cover, for example a foil, tightly provided about the closure element, the wire and a portion of the bottleneck, wherein the closure element (54) at least on the surface is of a material which is inert relative to the liquor so that neither taste nor colour is transferred from said material to the liquor.

60. Closure device according to claim 59, wherein the cork (54) is expandable, preferably permanently.

61. Closure device according to claim 59, wherein the cork (54) is coated with said inert material.

62. Use of a closure device for containing a carbonated liquid in a container under pressure such that the pressure remains in the container wherein the liquid is carbonated liquor.

63. Use according to claim 62, wherein the closure device comprises a cork.

64. Use according to claim 62, wherein the container is a bottle.
